(19) United States
(12) Patent Application Publication
(10) Pub. No.: US 2025/0163887 A1
(43) Pub. Date: May 22, 2025

(54) METHOD OF CONTROLLING TONAL NOISE FROM A WIND TURBINE

(71) Applicant: Vestas Wind Systems A/S, Aarhus N. (DK)

(72) Inventors: Mranal Gupta, Tilst (DK); Helge Schnehle, Flensburg (DE); Kaj Dam Madsen, Aarhus C (DK); Siddharth Ashar, Egå (DK)

(73) Assignee: Vestas Wind Systems A/S, Aarhus N. (DK)

(21) Appl. No.: 18/839,057

(22) PCT Filed: Feb. 13, 2023
(86) PCT No.: PCT/DK2023/050025

§ 371 Date: Aug. 16, 2024

(30) Foreign Application Priority Data
Feb. 17, 2022 (DK) PA 2022 70062

(51) Int. Cl. F03D 7/02; F03D 7/04

(52) U.S. Cl. CPC F03D 7/0296; F03D 7/0298; F03D 7/046; F05B 2260/962; F05B 2270/333; F05B 2270/334

(57) ABSTRACT

A method of controlling airborne tonal noise which originates from a component of a wind turbine, the wind turbine comprising a vibration control system comprising a plurality of actuators. The method comprising identifying a first operating state of the wind turbine; and selecting a first set of one or more of the actuators on the basis of the identified first operating state. Each actuator of the first set is operated to apply a vibration control oscillation to the component in phase opposition to a vibration of the component, thereby damping the vibration of the component and in turn reducing airborne tonal noise originating from the component. A change of the wind turbine to a second operating state is detected, then a second set of one or more of the actuators is selected on the basis of the identified second operating state. Each actuator of the second set is operated to apply a vibration control oscillation to the component in phase opposition to a vibration of the component, thereby damping the vibration of the component and in turn reducing airborne tonal noise originating from the component.

### FIELD OF THE INVENTION

The present invention relates to a method of controlling airborne tonal noise which originates from a component of a wind turbine.

### BACKGROUND OF THE INVENTION

A known method of controlling airborne tonal noise which originates from a component of a wind turbine is disclosed in WO 2021/197558A1. A component is arranged to receive a vibration from a vibration source and a resonator module is operably coupled to the component. An induced vibration from the resonator module destructively interferes with the vibration induced by the vibration source such that the magnitude of the vibration in the component is reduced.

### SUMMARY OF THE INVENTION

A first aspect of the invention provides a method of controlling airborne tonal noise which originates from a component of a wind turbine, the wind turbine comprising a vibration control system comprising a plurality of actuators, the method comprising: identifying a first operating state of the wind turbine; selecting a first set of one or more of the actuators on the basis of the identified first operating state; operating each actuator of the first set to apply a vibration control oscillation to the component in phase opposition to a vibration of the component, thereby damping the vibration of the component and in turn reducing airborne tonal noise originating from the component; identifying a change of the wind turbine to a second operating state; selecting a second set of one or more of the actuators on the basis of the identified second operating state, wherein the second set is different to the first set; and operating each actuator of the second set to apply a vibration control oscillation to the component in phase opposition to a vibration of the component, thereby damping the vibration of the component and in turn reducing airborne tonal noise originating from the component.

Optionally the first operating state of the wind turbine is associated with a first deflection shape and the second operating state of the wind turbine is associated with a second deflection shape, wherein the second deflection shape is different to the first deflection shape.

Optionally each vibration control oscillation is applied by measuring the vibration of the component to generate a vibration measurement; generating an actuator control signal in phase opposition to the vibration measurement; and driving the actuator with the actuator control signal.

Optionally the operating states of the wind turbine are identified by monitoring a rotor speed of the wind turbine, a power of the wind turbine and/or a blade pitch of the wind turbine.

Optionally the first or second set of one or more of the actuators is identified by inputting the operating state, or one or more operating parameters of the wind turbine, into a look-up table.

Optionally at least one of the vibration control oscillations is applied by measuring the vibration of the component to generate a vibration measurement; generating an actuator control signal in phase opposition to the vibration measurement; applying a gain factor to reduce an amplitude of the actuator control signal, thereby generating a reduced-amplitude actuator control signal; and driving the actuator with the reduced-amplitude actuator control signal.

A further aspect of the invention provides a method of controlling airborne tonal noise which originates from a component of a wind turbine, the wind turbine comprising a vibration control system, the method comprising: measuring vibration of the component to generate a vibration measurement; generating an actuator control signal in phase opposition to the vibration measurement; applying a gain factor to reduce an amplitude of the actuator control signal, thereby generating a reduced-amplitude actuator control signal; and driving the vibration control system with the reduced-amplitude actuator control signal so that the vibration control system applies a vibration control oscillation to the component in phase opposition to a vibration of the component, thereby reducing, but not cancelling, the vibration of the component and in turn reducing airborne tonal noise originating from the component. The vibration control system may comprise one or more actuators and the vibration control system may be driven by applying the reduced-amplitude actuator control signal to the one or more actuators.

Optionally the gain factor reduces the amplitude of the actuator control signal by a factor of 25% or more, or by a factor of 50% or more.

Optionally the method further comprises determining the gain factor by operating the vibration control system to apply a calibration oscillation to the component in phase opposition to a vibration of the component; varying an amplitude of the calibration oscillation; monitoring a response of airborne tonal noise to the varying amplitude of the calibration oscillation; and determining the gain factor on the basis of the monitored response of the airborne tonal noise.

Optionally applying the calibration oscillation causes a vibration mode of the component to oscillate at a resultant amplitude; varying an amplitude of the calibration oscillation comprises reducing an amplitude of the calibration oscillation; and the reduction of the amplitude of the calibration oscillation causes the resultant amplitude of the vibration mode to increase and the airborne tonal noise to decrease.

Optionally the response of the airborne tonal noise is monitored by one or more microphones.

Optionally the airborne tonal noise originates at the component of the wind turbine and is emitted via plural transfer paths and/or plural radiators.

Optionally the component comprises a gearbox.

Optionally each operating state is defined by a range of one or more operating parameters of the wind turbine; and identifying the operating state of the wind turbine comprises measuring the one or more operating parameters and determining that the one or more operating parameters fall within the range.

Optionally each operating state is defined by one or more operating parameters of the wind turbine; identifying the operating state of the wind turbine comprises making a first measurement of the one or more operating parameters; identifying a change of the wind turbine to a second operating state comprises making a second measurement of the one or more operating parameters; and the first and second sets of actuators are selected by a trained model on the basis of the first and second measurements respectively.

Optionally the trained model has been trained by machine learning.

Optionally the method further comprises training the trained model by machine learning.

A further aspect of the invention provides apparatus for controlling airborne tonal noise which originates from a component of a wind turbine, the apparatus comprising: a vibration control system configured to apply a vibration control oscillation to the component; and a control system configured to operate the vibration control system to control airborne tonal noise by a method according to any preceding aspect.

A further aspect of the invention provides a computer program product comprising software code adapted to control a vibration control system when executed on a data processing system, the computer program product being adapted to perform the method of any preceding aspect.

### BRIEF DESCRIPTION OF THE DRAWINGS

Embodiments of the invention will now be described with reference to the accompanying drawings, in which:

FIG. 1 shows a wind turbine;

FIG. 2 shows various control elements of the wind turbine;

FIG. 3 shows an operating envelope of the wind turbine, and four operating states associated with tonal noise;

FIG. 4 shows a gearbox and vibration control system;

FIG. 5 shows apparatus for controlling airborne tonal noise;

FIG. 6 is a flow diagram illustrating a preferred method of operating the vibration control system;

FIG. 7 shows transfer paths and radiators which emit tonal noise

FIG. 8 is a schematic diagram illustrating a structure driven by two excitations;

FIG. 9 shows the structure of FIG. 8 with a vibration control oscillation being applied with a 100% gain factor;

FIG. 10 shows the structure of FIG. 8 with a vibration control oscillation being applied with a gain factor below 100%;

FIG. 11 is a flow diagram illustrating a method of setting a gain factor.

### DETAILED DESCRIPTION OF EMBODIMENT(S)

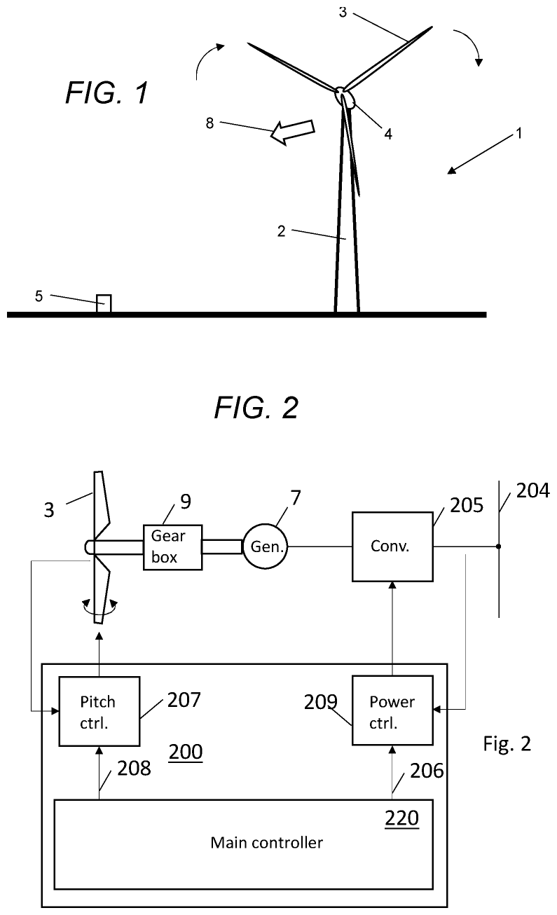

FIG. 1 shows a wind turbine 1 comprising a rotor-nacelle-assembly (RNA) 3, 4 mounted on a tower 2. The RNA comprises a nacelle 4 to which a rotor 3 is mounted. The rotor 3 comprises a plurality of wind turbine blades that extend radially from a central hub. In this example, the rotor 3 comprises three blades. The RNA 3, 4 can be rotated about a vertical yaw axis to change its yaw angle.

The wind turbine 1 may be included among a collection of other wind turbines belonging to a wind power plant, also referred to as a wind farm or wind park, that serve as a power generating plant connected by transmission lines with a power grid. The power grid generally consists of a network of power stations, transmission circuits, and substations coupled by a network of transmission lines that transmit the power to loads in the form of end users and other customers of electrical utilities.

FIG. 2 schematically illustrates an embodiment of a control system 200 together with elements of the wind turbine 1. The rotor 3 is mechanically connected to an electrical generator 7 via a gearbox 9. The electrical power generated by the generator 7 is injected into a power grid 204 via an electrical converter 205. The electrical generator 7 and the converter 205 may be based on a full scale converter (FSC) architecture or a doubly fed induction generator (DFIG) architecture, but other types may be used.

The control system 200 comprises a number of elements, including at least one main controller 220 with a processor and a memory, so that the processor is capable of executing computing tasks based on instructions stored in the memory. In general, the main controller 220 ensures that in operation the wind turbine generates a requested power output level. This is obtained by adjusting the pitch angle of the blades and/or 30 the power extraction of the converter 205. To this end, the control system 200 comprises a pitch system including a pitch controller 207 using a pitch reference signal 208, and a power system including a power controller 209 using a power reference signal 206. The wind turbine rotor 3 comprises rotor blades that can be pitched by a pitch mechanism. The rotor comprises an individual pitch system which is capable of individual pitching of the rotor blades, and may comprise a common pitch system which adjusts all pitch angles on all rotor blades at the same time. The control system 200, or elements of the control system 200, may be placed in a power plant controller (not shown) so that the turbine may be operated based on externally provided instructions.

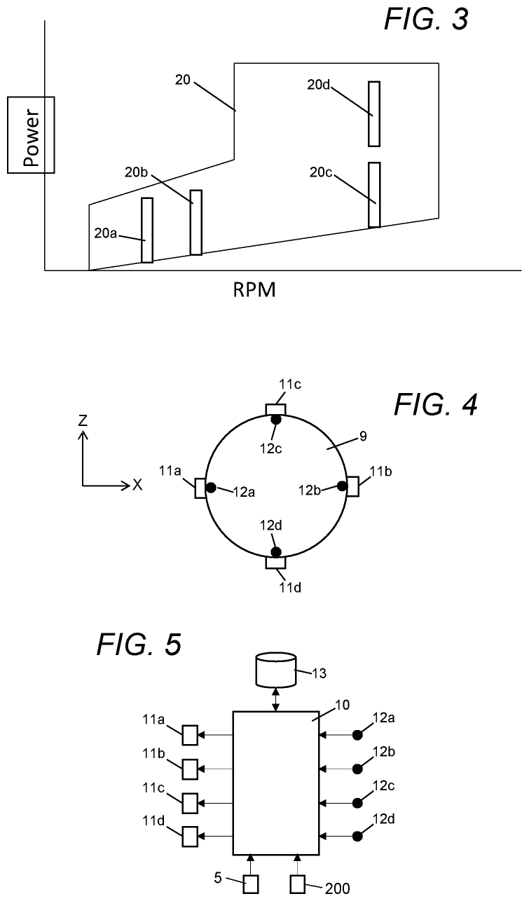

FIG. 3 shows an operating envelope 20 of the wind turbine. The X-axis of FIG. 3 indicates the rotor speed, i.e. the rotation rate of the rotor 3. The Y-axis of FIG. 3 indicates the power being generated by the wind turbine. By way of example the power may be determined by the power reference signal 206 mentioned above. The wind turbine operates within a limited range of rotor speed and power, as indicated by the operating envelope 20.

Within the operating envelope 20, four operating states 20a-d are indicated, each operating state being defined by a rotor speed range and a power range. By way of example, the first operating state 20a may be defined by a rotor speed range of 250-270 RPM and a power range of 500-750 kW. The parameters of the operating states 20a-d may be predetermined and stored in a memory 13 shown in FIG. 5.

Each operating state 20a-d is associated with a respective different motion of the wind turbine 1 and/or the gearbox 9 which results in the generation of airborne tonal noise originating from the gearbox 9. For example the first operating state 20a may be associated with a rolling motion, the second operating state 20b may be associated with a pitching motion, the third operating state 20c may be associated with a vertical translation and the fourth operating state 20d may be associated with an axial pumping motion (in the Y-direction in line with the rotor axis). So as the rotor speed increases, and the wind turbine changes from the first operating state 20a to the second operating state 20b, the dominant mode of motion changes from a rolling motion to a pitching motion.

In this simplified example, each operating state 20a-d is associated with only a single mode of vibration, but in general each operating mode may be associated with a mixture of different modes of vibration.

The various different types of motion will cause the gearbox 9 to deflect differently, so that each operating state of the wind turbine is associated with a different deflection shape which in turn is associated with a different type of tonal noise. So for example the first operating state 20a of the wind turbine may be associated with a first deflection shape caused by the rolling motion, and the second operating state 20b of the wind turbine may be associated with a second deflection shape caused by the pitching motion. The second deflection shape is different to the first deflection shape.

FIG. 4 shows the gearbox 9 in vertical section orthogonal to the rotor axis. The vertical (Z) direction is indicated, along with the X direction. The rotor (Y) axis is orthogonal to FIG. 4.

FIG. 5 schematically illustrates apparatus for controlling airborne tonal noise which originates from the gearbox 9. Note that the gearbox 9 is used an example of a component of the wind turbine 1 which can be a source of the tonal noise 8, but other embodiments of the invention may control airborne tonal noise from other components of the wind turbine, such as the generator 7.

The apparatus of FIG. 5 comprises a vibration control system comprising a plurality of actuators 11a-d configured to apply a vibration control oscillation to the gearbox 9, and a plurality of vibration sensors 12a-d configured to measure vibration of the gearbox 9 to generate vibration measurements. The actuators 11a-d and sensors 12a-d may be mounted to the gearbox 9 as shown in FIG. 4, or otherwise coupled to the gearbox 9 by a rigid connection.

By way of example, each actuator/sensor pair 11a/12a, 11b/12b etc. may be integrated into a single active damping device, for example an ADD.Sound® device as supplied by Woelfel, with details at https://www.woelfel.de/en/wind-energy/vibration-reduction.html#tab-conent-22916 (as on 9 Feb. 2022). See also a brochure available on 9 Feb. 2022 at: https://www.woelfel.de/fileadmin/produkte/schwingungsminderung/download/2016-08-brochure-ADD-sound.pdf

Other examples of suitable active damping devices can be found in EP-A1-1927782, EP-A1-2916031, EP-A1-2730709 and WO 2021/197558A1.

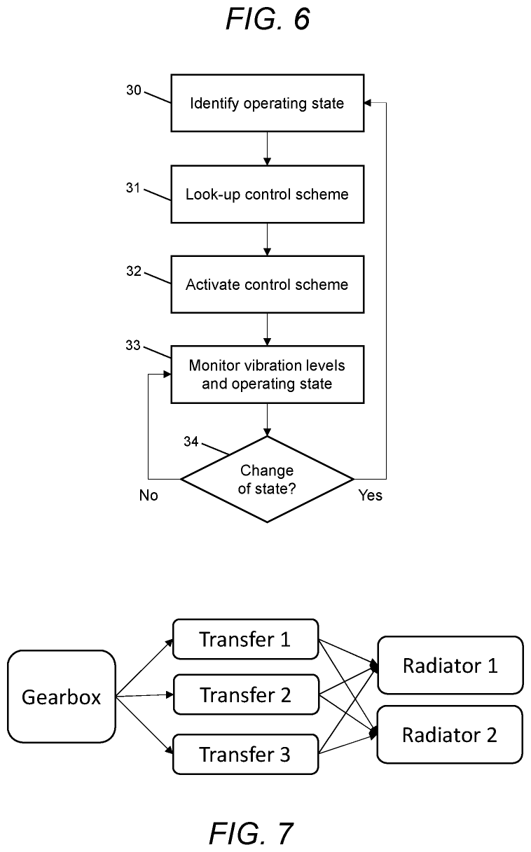

A control system 10 is configured to operate the vibration control system 11a-d, 12a-d to control the airborne tonal noise 8 by a method shown in FIG. 6. The control system may be implemented in software, as a computer program product comprising software code adapted to control the vibration control system 11a-d, 12a-d when executed on a data processing system, the computer program product being adapted to perform the method of FIG. 6.

In step 30 of the method, an operating state of the wind turbine is identified—for instance the first operating state 20a. The operating state is determined by receiving the rotor speed and power from the control system 200 and comparing them with the parameters of the operating states 20a-d stored in the memory 13.

In step 31, the identified operating state is input into a look-up table. Table 1 below gives an example of a look-up table.

TABLE 1

| State | Shape | Gain 1 | Gain 2 | Gain 2 | Gain 2 | Phase |
|---|---|---|---|---|---|---|
| ODS1 | Rolling | 100% | 100% | 0 | 0 | Out of |
| | | | | | | phase |
| ODS2 | Pitching | 0 | 0 | 75% | 75% | Out of |
| | | | | | | phase |
| ODS3 | Vertical | 50% | 50% | 0 | 0 | In phase |
| | translation | | | | | |
| ODS4 | Axial | 0 | 0 | 25% | 25% | In phase |
| | pumping | | | | | |

Each row of Table 1 indicates a control scheme associated with a different operating state. The operating states 20a-d are designated in Table 1 as ODS1, ODS2, ODS3 and ODS4. Each control scheme has a set of four gain factors, each associated with a respective one of the actuators 11a-d. Gain 1 is a gain factor associated with a first actuator 11a on a left side of the gearbox 9, Gain 2 is a gain factor associated with a second actuator 11b on a right side of the gearbox 9, Gain 3 is a gain factor associated with a third actuator 11a at the top of the gearbox 9, and Gain 4 is a gain factor associated with a fourth actuator 11d at the bottom of the gearbox. Note that the gain factors in Table 1 are illustrative only, and not necessarily indicative of gain factors which will be applied in practice.

In step 32, the control scheme output by the look-up table is activated. Each control scheme selects a set of one or more of the actuators. Each actuator of the selected set is operated in step 32 to apply a vibration control oscillation to the gearbox 9 in phase opposition to a vibration of the component, thereby damping the vibration of the component and in turn reducing airborne tonal noise 8 originating from the gearbox 9.

Each actuator 11a-d is associated with a respective sensor 12a-d. For each actuator, the vibration control oscillation is applied by measuring the vibration of the gearbox with its associated sensor to generate a vibration measurement; generating an actuator control signal in phase opposition to the vibration measurement and with the same amplitude as the vibration measurement; optionally applying a gain factor to reduce an amplitude of the actuator control signal, thereby generating a reduced-amplitude actuator control signal; and driving the actuator with the reduced-amplitude actuator control signal.

The first control scheme associated with the first operation state ODS1 selects a first set of the actuators (in this case, the actuators 11a, 11b on the sides of the gearbox) which are driven out of phase with each other with a gain factor of 100%. So in the case of ODS1 the actuator control signal is at full amplitude (i.e. the same amplitude as the vibration measurement) so the vibration is fully cancelled. The actuators 11c, 11d on the top and bottom of the gearbox have gain factors of 0 so they are not driven.

According to the first control scheme, each actuator 11a, 11b of the first set is operated to apply a vibration control oscillation to the gearbox 9 in the X-direction, in phase opposition to the vibration of the gearbox 9 caused by the side-to-side rolling motion.

The second control scheme associated with the second operation state ODS2 selects a second set of the actuators (in this case, the actuators 11c, 11d on the top and bottom of the gearbox) which are driven out of phase with each other with a gain factor of 75%. Thus the gain factor reduces the amplitude of the actuator control signal by a factor of 25%, thereby generating a reduced-amplitude actuator control signal. So in the case of ODS2 the reduced-amplitude actuator control signal is at a lower amplitude than the vibration measurement. As a result, the vibration is only partially cancelled—in other words it is reduced but not cancelled. The actuators 11a, 11b on the sides of the gearbox have gain factors of 0 so they are not driven.

According to the second control scheme, each actuator 11c, 11d of the second set is operated to apply a vibration control oscillation to the gearbox 9 in the Y-direction, in phase opposition to the vibration of the gearbox 9 caused by the vertical pitching motion.

The third control scheme associated with the third operation state ODS3 selects the first set of the actuators (the actuators 11a, 11b on the sides of the gearbox) which are driven in phase with each other with a gain factor of 50%. Thus the gain factor reduces the amplitude of the actuator control signal by a factor of 50%, thereby generating a reduced-amplitude actuator control signal. So in the case of ODS3 the reduced-amplitude actuator control signal is at a much lower amplitude than the vibration measurement and the vibration is only partially cancelled. The actuators 11c, 11d on the top and bottom of the gearbox have gain factors of 0 so they are not driven.

According to the third control scheme, each actuator 11a, 11b of the first set is operated to apply a vibration control oscillation to the gearbox 9 in the Z-direction, in phase opposition to the vibration of the gearbox 9 caused by the vertical translation motion.

The fourth control scheme associated with the fourth operation state ODS4 selects the second set of the actuators (the actuators 11c, 11d on the top and bottom of the gearbox) which are driven in phase with each other with a gain factor of 25%. Thus the gain factor reduces the amplitude of the actuator control signal by a factor of 75%, thereby generating a reduced-amplitude actuator control signal. So in the case of ODS4 the reduced-amplitude actuator control signal is at a significantly lower amplitude than the vibration measurement and the vibration is only partially cancelled. The actuators 11a, 11b on the sides of the gearbox have gain factors of 0 so they are not driven.

According to the fourth control scheme, each actuator 11c, 11d of the second set is operated to apply a vibration control oscillation to the gearbox 9 in the Y-direction, in phase opposition to the vibration of the gearbox 9 caused by the axial pumping motion.

It should be noted that Table 1 is a schematic example of a set of four control schemes, each associated with only a single vibration mode. In other examples, the control schemes may be more complex, for instance they may be designed to control more than a single vibration mode.

The operating states 20a-d are identified by monitoring a rotor speed of the wind turbine and a power of the wind turbine, but other operating parameters of the wind turbine may be used such as the blade pitch set by the pitch reference signal 208.

In step 33, the amplitude and phase of the vibration measurements from the sensors 12a-d are continuously monitored and the actuator control signals adjusted, if necessary, to ensure that they remain in phase opposition to the vibration measurement and at the correct amplitude.

If a change to a new operation state is identified at step 34, then the process returns to step 30 where the new operation state is identified. If the wind turbine is not operating in any of the operating states 20a-d, then little tonal noise is being generated so no vibration control oscillations are applied.

In summary, by following the process of FIG. 6, in a first iteration of step 30 the control system 10 may identify a first operating state of the wind turbine (for instance OBS 1); then in step 31 it selects a first set of one or more of the actuators (for instance actuators 11a, 11b) on the basis of the identified first operating state; and then in step 32 it operates each actuator of the first set to apply a vibration control oscillation to the gearbox in phase opposition to a vibration of the gearbox. This damps the vibration of the gearbox and in turn reduces airborne tonal noise 8 originating from the gearbox.

In a second iteration of step 30, the control system 10 may identify a change of the wind turbine to a second operating state (for instance OBS 2); then in step 31 it selects a second set of one or more of the actuators (for instance actuators 11c, 11d) on the basis of the identified second operating state, and then in step 32 it operates each actuator of the second set to apply a vibration control oscillation to the gearbox 9 in phase opposition to a vibration of the gearbox, thereby damping the vibration of the gearbox and in turn reducing airborne tonal noise 8 originating from the gearbox.

In an alternative process the control system 10 may operate the vibration control system without making any reference to the operating state of the wind turbine, in order to completely cancel the vibrations of the gearbox, regardless of whether the vibrations contribute to tonal noise.

This alternative process has two problems. A first problem is that the vibration control system may be cancelling vibrations of the gearbox which do not result in airborne tonal noise—i.e. airborne acoustic noise with spectral tones which are pure tone in nature. This results in unnecessary complexity and energy consumption by the vibration control system. A second problem is that some vibration control oscillations may reduce certain modes of vibration of the gearbox but lead to an increase in airborne acoustic tonal noise.

The first problem may be solved by the process of FIG. 6. This process selects a set of one or more actuators, based on the operating state of the wind turbine, and in doing so it only seeks to reduce vibrations which are known to result in the emission of airborne tonal noise.

The second problem may also be solved by the process of FIG. 6, as will be explained further with reference to FIGS. 7-10.

The wind turbine 1 emits airborne tonal noise 8 which originates at the gearbox 9 and may be emitted via plural transfer paths and plural radiators as shown in FIG. 7. In this example there are three transfer paths (Transfer 1, Transfer 2, Transfer 3) and two radiators (Radiator 1 and Radiator 2). For example the radiators may be the nacelles 4 and the tower 2, and the transfer paths may be different structures which couple the gearbox 9 to the radiators.

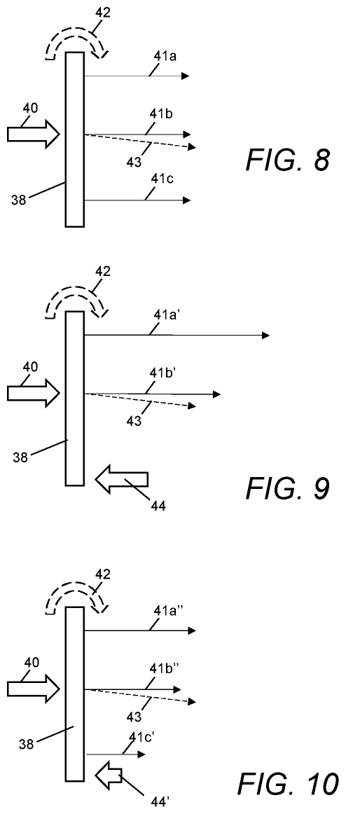

Surprisingly, it has been found that a reduction of vibration via one transfer path can result in amplification via another transfer path. This phenomenon is illustrated in FIGS. 8-10 which shows a structure 38 driven by a first excitation 40 which causes the structure 38 to vibrate in a translational degree-of-freedom, and a second excitation 42 which causes the structure 38 to vibrate in a rotational degree-of-freedom, rotating about the bottom of the structure 38. The first excitation 40 causes translational vibrations 41a-c which are transmitted via respective different transfer paths, and the second excitation 43 causes a rotational vibration 43 which is transmitted via another transfer path. The lengths of the arrows indicating the vibrations 41a-c and 43 are indicative of their respective amplitudes.

In FIG. 9, an actuator applies a vibration control oscillation 44 to the structure 30 in phase opposition to the vibration 41c and with the same amplitude as the vibration 41c. This completely cancels the vibration 41c, essentially holding the bottom of the structure 38 stationary. Since the bottom of the structure 38 is now stationary, the energy of the first excitation 40 now drives rotation about the bottom of the structure 38 so the rotational vibrations 41b and 41c are amplified to higher levels as indicated by the longer arrows 41b′ and 41c′ in FIG. 9. This may result in an increase in airborne tonal noise.

A solution to this problem is to apply a gain factor so the amplitude of the vibration control oscillation 44 is lowered to a reduced level as indicated by arrow 44′ in FIG. 10. The reduction of the amplitude of the vibration control oscillation causes the bottom of the structure 38 to vibrate as indicated by vibration 41c′, albeit at a reduced level compared with FIG. 8. However, this is outweighed by a decrease in the other vibrations to reduced levels 41a″, 41b″ (compared with FIG. 9) which leads to an overall decrease in the airborne tonal noise originating from the structure 38.

The principle of FIG. 10 is applied by the control schemes of Table 1: some of the gain factors being less than 100% in order to minimise the overall airborne tonal noise 8, rather than being set to 100% to cancel a particular vibration mode.

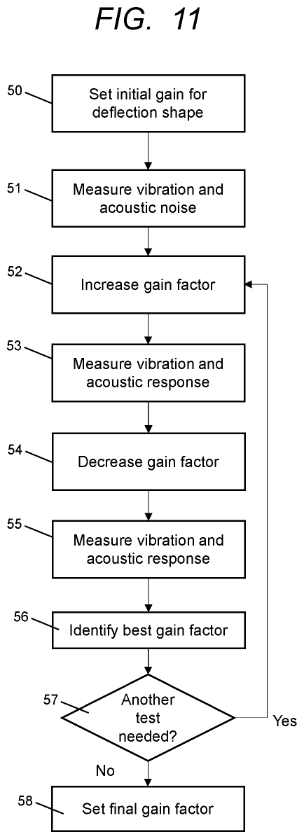

The gain factors may be determined in a calibration process shown in FIG. 11. In step 50, the vibration control system 11a-d, 12a-d is operated to apply a calibration oscillation to the gearbox 9 in phase opposition to a vibration of the gearbox 9, according to one of the control schemes (for instance the first control scheme associated with OBS 1).

The gain factor in step 50 is set to an initial level. In step 51, the sensors 12a-d measure vibration of the gearbox 9, and one or microphones 5 shown in FIG. 1 are operated to record airborne acoustic noise. The microphone 5 may be an International Electrotechnical Commission (IEC) microphone which records sound pressure some distance from the wind turbine.

In steps 52-56 an amplitude of the calibration oscillation is varied, a response of the airborne tonal noise 8 to the varying amplitude is monitored, and the best gain factor is determined on the basis of the monitored response of the airborne tonal noise 8.

More specifically, the amplitude of the calibration oscillation is increased above the initial level in step 52 (by increasing the gain factor) and in step 53 the vibration of the gearbox is measured by the sensors 12a-d and the acoustic response of the tonal noise 8 is measured by the microphone 5. Then in step 54 the amplitude of the calibration oscillation is decreased below the initial level, and in step 55 the vibration of the gearbox is measured by the sensors 12a-d and the acoustic response of the tonal noise 8 is measured by the microphone 5.

In step 56 the best gain factor is identified—i.e. the gain factor which results in the lowest airborne acoustic tonal noise 8. This may be the current (initial) gain factor, the increased gain factor or the decreased gain factor.

As explained in FIGS. 8-10, it is possible that the decreased gain factor applied in step 54 will result in a lowering of the lowest acoustic tonal noise compared with the current gain factor. In this case, applying the calibration oscillation in step 50 causes a vibration mode of the component to oscillate at a resultant amplitude (which may be zero—i.e. full cancellation in the case of a 100% gain factor); and the reduction of the amplitude of the calibration oscillation at step 54 causes the resultant amplitude of the vibration mode to increase and the airborne tonal noise to decrease.

In step 57 a determination is made whether another test is needed. If the current gain factor has been identified as the best gain factor, then another test is not needed and the final gain factor is set at step 57 as the current gain factor. If the increased or decreased gain factor is identified in step 56, then another test is needed and steps 52-57 are repeated, starting from whichever gain factor has been identified in step 56.

Steps 52-57 are repeated until an optimal current gain factor has been identified, and this is set as the gain factor in step 58.

The calibration process is repeated for each control scheme, so optimal gain factors are identified for each control scheme.

In the examples above, the control scheme is selected by first identifying the operating state based on operating parameters of the wind turbine (speed and power) and then inputting the operating state into a look-up table. Each operating state may be defined by a range of one or more operating parameters of the wind turbine (for instance speed and power) and each operating state of the wind turbine may be identified by measuring the one or more operating parameters and determining that they fall within the range. Optionally the operating parameters may be input into the look-up table rather than the operating state.

In other examples of the present invention the control scheme may be identified in some other way, for example by inputting one or more operating parameters into a trained model which has been trained by machine learning, the model outputting the control scheme.

In such machine learning examples, each operating state may be defined by one or more operating parameters of the wind turbine, rather than by ranges of such operating parameters. Identifying the operating state of the wind turbine may comprise making a first measurement of the one or more operating parameters; and identifying a change of the wind turbine to a second operating state may comprise making a second measurement of the one or more operating parameters. The first and second sets of actuators may be selected by the trained model on the basis of the first and second measurements respectively.

In such machine learning examples, the method may comprise: measuring one or more operating parameters of the wind turbine (for example rotor speed, rotor speed gradient (acceleration), rotor torque, rotor torque gradient, and/or or vibration measurements); inputting the one or more wind turbine parameters into a trained model so that the trained model selects a set of one or more of the actuators on the basis of the one or more wind turbine parameters; and operating each actuator of the set to apply a vibration control oscillation to the component in phase opposition to a vibration of the component, thereby damping the vibration of the component and in turn reducing airborne tonal noise originating from the component.

The trained model may be trained by machine learning, for instance by inputting a training set of the one or more operating parameters into an untrained model.

The trained model may output a control scheme similar to one of the control schemes shown in Table 1—i.e. not only the set of one or more actuators associated with the current value(s) of the operating parameters, but also the gain factors which are applied to reduce the amplitude of the actuator control signal(s).

The training set may be obtained by randomisation of gains and combinations of different actuators. This may be done by sweeping through all possible combinations with an optimizer that carves out unnecessary areas based on interim learnings, or a mesh approach which goes from bigger steps to smaller steps (low resolution meshing and then high resolution meshing).

The machine learning process may use a trained model which receives the one or more operating parameters as inputs, and outputs a control scheme which seeks to minimize the tone line level—in other words to minimize the airborne tonal noise 8 as measured by the microphone(s) 5 shown in FIG. 1.

Although the invention has been described above with reference to one or more preferred embodiments, it will be appreciated that various changes or modifications may be made without departing from the scope of the invention as defined in the appended claims.

1.-15. (canceled)

16. A method of controlling airborne tonal noise which originates from a component of a wind turbine and is emitted via plural transfer paths and plural radiators, the wind turbine comprising a vibration control system comprising a plurality of actuators, the method comprising: identifying a first operating state of the wind turbine; selecting a first set of one or more of the actuators on the basis of the identified first operating state; operating each actuator of the first set to apply a vibration control oscillation to the component in phase opposition to a vibration of the component, thereby damping the vibration of the component and in turn reducing airborne tonal noise originating from the component; identifying a change of the wind turbine to a second operating state; selecting a second set of one or more of the actuators on the basis of the identified second operating state, wherein the second set is different to the first set; and operating each actuator of the second set to apply a vibration control oscillation to the component in phase opposition to a vibration of the component, thereby damping the vibration of the component and in turn reducing airborne tonal noise originating from the component.

17. The method according to claim 16, wherein the first operating state of the wind turbine is associated with a first deflection shape and the second operating state of the wind turbine is associated with a second deflection shape, wherein the second deflection shape is different to the first deflection shape.

18. The method according to claim 16, wherein each vibration control oscillation is applied by measuring the vibration of the component to generate a vibration measurement; generating an actuator control signal in phase opposition to the vibration measurement; and driving the actuator with the actuator control signal.

19. The method according to claim 16, wherein the operating states of the wind turbine are identified by monitoring a rotor speed of the wind turbine, a power of the wind turbine and/or a blade pitch of the wind turbine.

20. The method according to claim 16, wherein the first or second set of one or more of the actuators is identified by inputting the operating state, or one or more operating parameters of the wind turbine, into a look-up table.

21. The method according to claim 16, wherein at least one of the vibration control oscillations is applied by measuring the vibration of the component to generate a vibration measurement; generating an actuator control signal in phase opposition to the vibration measurement; applying a gain factor to reduce an amplitude of the actuator control signal, thereby generating a reduced-amplitude actuator control signal; and driving the actuator with the reduced-amplitude actuator control signal.

22. The method according to claim 21, wherein the gain factor reduces the amplitude of the actuator control signal by a factor of 25% or more, or by a factor of 50% or more.

23. The method according to claim 21, further comprising determining the gain factor by operating the vibration control system to apply a calibration oscillation to the component in phase opposition to a vibration of the component; varying an amplitude of the calibration oscillation; monitoring a response of airborne tonal noise to the varying amplitude of the calibration oscillation; and determining the gain factor on the basis of the monitored response of the airborne tonal noise.

24. The method according to claim 23, wherein applying the calibration oscillation causes a vibration mode of the component to oscillate at a resultant amplitude; varying an amplitude of the calibration oscillation comprises reducing an amplitude of the calibration oscillation; and the reduction of the amplitude of the calibration oscillation causes the resultant amplitude of the vibration mode to increase and the airborne tonal noise to decrease.

25. The method according to claim 16, wherein the gain factor reduces the amplitude of the actuator control signal by a factor of 25% or more, or by a factor of 50% or more.

26. The method according to claim 16, further comprising determining the gain factor by operating the vibration control system to apply a calibration oscillation to the component in phase opposition to a vibration of the component; varying an amplitude of the calibration oscillation; monitoring a response of airborne tonal noise to the varying amplitude of the calibration oscillation; and determining the gain factor on the basis of the monitored response of the airborne tonal noise.

27. The method according to claim 26, wherein applying the calibration oscillation causes a vibration mode of the component to oscillate at a resultant amplitude; varying an amplitude of the calibration oscillation comprises reducing an amplitude of the calibration oscillation; and the reduction of the amplitude of the calibration oscillation causes the resultant amplitude of the vibration mode to increase and the airborne tonal noise to decrease.

28. The method according to claim 16, wherein each operating state is defined by a range of one or more operating parameters of the wind turbine; and identifying the operating state of the wind turbine comprises measuring the one or more operating parameters and determining that the one or more operating parameters fall within the range.

29. The method according to claim 16, wherein each operating state is defined by one or more operating parameters of the wind turbine; identifying the operating state of the wind turbine comprises making a first measurement of the one or more operating parameters; identifying a change of the wind turbine to a second operating state comprises making a second measurement of the one or more operating parameters; and the first and second sets of actuators are selected by a trained model on the basis of the first and second measurements respectively.

30. A method of controlling airborne tonal noise which originates from a component of a wind turbine and is emitted via plural transfer paths and plural radiators, the wind turbine comprising a vibration control system comprising a plurality of actuators, the method comprising: measuring vibration of the component to generate a vibration measurement; generating an actuator control signal in phase opposition to the vibration measurement; applying a gain factor to reduce an amplitude of the actuator control signal, thereby generating a reduced-amplitude actuator control signal; and driving the vibration control system with the reduced-amplitude actuator control signal so that the actuators of the vibration control system apply a vibration control oscillation to the component in phase opposition to a vibration of the component, thereby reducing, but not cancelling, the vibration of the component and in turn reducing airborne tonal noise originating from the component.

31. The method according to claim 30, wherein the gain factor reduces the amplitude of the actuator control signal by a factor of 25% or more, or by a factor of 50% or more.

32. The method according to claim 30, further comprising determining the gain factor by operating the vibration control system to apply a calibration oscillation to the component in phase opposition to a vibration of the component; varying an amplitude of the calibration oscillation; monitoring a response of airborne tonal noise to the varying amplitude of the calibration oscillation; and determining the gain factor on the basis of the monitored response of the airborne tonal noise.

33. The method according to claim 32, wherein applying the calibration oscillation causes a vibration mode of the component to oscillate at a resultant amplitude; varying an amplitude of the calibration oscillation comprises reducing an amplitude of the calibration oscillation; and the reduction of the amplitude of the calibration oscillation causes the resultant amplitude of the vibration mode to increase and the airborne tonal noise to decrease.

34. The method according to claim 30, wherein each operating state is defined by a range of one or more operating parameters of the wind turbine; and identifying the operating state of the wind turbine comprises measuring the one or more operating parameters and determining that the one or more operating parameters fall within the range.

35. The method according to claim 30, wherein each operating state is defined by one or more operating parameters of the wind turbine; identifying the operating state of the wind turbine comprises making a first measurement of the one or more operating parameters; identifying a change of the wind turbine to a second operating state comprises making a second measurement of the one or more operating parameters; and the first and second sets of actuators are selected by a trained model on the basis of the first and second measurements respectively.

36. An apparatus for controlling airborne tonal noise which originates from a component of a wind turbine, the apparatus comprising: a vibration control system configured to apply a vibration control oscillation to the component; and a control system configured to operate the vibration control system to control airborne tonal noise by a method according to claim 16.

37. An apparatus for controlling airborne tonal noise which originates from a component of a wind turbine, the apparatus comprising: a vibration control system configured to apply a vibration control oscillation to the component; and a control system configured to operate the vibration control system to control airborne tonal noise by a method according to claim 30.

38. A computer program product comprising software code adapted to control a vibration control system when executed on a data processing system, the computer program product being adapted to perform the method of claim 16.

39. A computer program product comprising software code adapted to control a vibration control system when executed on a data processing system, the computer program product being adapted to perform the method of claim 30.
